(19) United States
(12) Patent Application Publication
(10) Pub. No.: US 2008/0197787 A1
(43) Pub. Date: Aug. 21, 2008

(54) Sinusoidal discharge for EL lamp

(75) Inventor: John Fredrick Nyman, Tempe, AZ (US)

Correspondence Address: Paul F. Wille;Cantor Colburn LLP, 55 Griffin Road South, Bloomfield, CT, 06002, US

(73) Assignee: World Properties, Inc., Lincolnwood, IL (US)

(21) Appl. No.: 11/708,555

(22) Filed: Feb. 20, 2007

(51) Int. Cl. H05B 41/26

(52) U.S. Cl. 315/246

(57) ABSTRACT

A driver for powering an EL lamp includes a boost circuit for converting low voltage DC to high voltage DC and an inverter for converting direct current to alternating current. The driver also includes at least one transistor for discharging,the EL lamp and a generator for producing a ramp voltage that is coupled to the base of the transistor. The ramp voltage causes the discharge current through the EL lamp to be sinusoidal, without harmonics. The discharge current does not cause the EL lamp to produce sound.

### BACKGROUND OF THE INVENTION

This invention relates to an electroluminescent (EL) lamp and, in particular, to a driver for powering an EL lamp without causing the lamp to produce sound.

An EL lamp is essentially a capacitor having a dielectric layer between two conductive electrodes, one of which is transparent. The dielectric layer may include a phosphor powder or there may be a separate layer of phosphor powder adjacent the dielectric layer. The phosphor powder radiates light in the presence of a strong electric field, using very little current. Because an EL lamp is a capacitor, alternating current must be applied to the electrodes to cause the phosphor to glow, otherwise the capacitor charges to the applied voltage, the current through the EL lamp ceases, and the lamp stops producing light.

In portable electronic devices, automotive displays, and other applications where the power source is a low voltage battery, an EL lamp is powered by a driver that converts low voltage direct current into high voltage alternating current. In order for an EL lamp to glow sufficiently, a peak-to-peak voltage in excess of about one hundred and twenty volts is necessary. The actual voltage depends on the construction of the lamp and, in particular, the field strength within the phosphor powder.

The prior art discloses several types of drivers that include a boost circuit having an inductor in series with a switching transistor. Current through the inductor causes energy to be stored in a magnetic field around the inductor. When the current is abruptly shut off, the induced magnetic field collapses, producing a pulse of high voltage. The voltage across the inductor is proportional to L•δi/δt. Thus, a low voltage at high current is converted into a high voltage at low current. The voltage on a storage capacitor, or the EL lamp itself, is pumped up by a series of pulses from the boost circuit.

As understood by those skilled in the art, an electrical circuit is physical, not mathematical. In other words, reference to a half cycle is not intended to have mathematical precision. Transistors take time to turn on and turn off, causing transition periods than make periods slightly different from exactly one half period or one quarter period. Nevertheless, in the vernacular of the art, a period is referred to as one half cycle or one quarter cycle.

As used herein, “ground” does not necessarily mean a connection to earth, merely a connection to electrical common or to a current return path.

As used herein, a bridge is a circuit having four arms with two pairs of arms connected in parallel between a first pair of terminals. In each pair of arms, the arms are connected in series. The junctions of the arms in each series pair are a second pair of terminals. With unidirectional current elements in the arms and alternate arms conducting simultaneously, a bridge has a DC diagonal across one pair of terminals and an AC diagonal across the second pair of terminals.

The direct current produced by the boost circuit must be converted into an alternating current in order to power an EL lamp. U.S. Pat. No. 4,210,848 (Suzuki et al.) and U.S. Pat. No. 4,527,096 (Kindlmann) disclose a switching bridge, known as an H-bridge, to alternate the current through an EL lamp. The bridge changes the polarity of the current through the lamp at a low frequency (200-1000 hertz). The H-bridge has an AC diagonal, coupled to an EL lamp, and a DC diagonal, coupled to a boost circuit. The bridge operates like a double pole, double throw switch, as illustrated in FIG. 1, to produce an alternating current through the EL lamp.

When an EL lamp is lit, the front and rear electrodes are oppositely charged and, therefore, are electrostatically attracted. Each cycle of the AC from a driver causes a slight but audible movement in the lamp. Thus, an EL lamp acts like an electrostatic speaker. It is known that a sinusoidal voltage causes substantially no noise to be emitted by an EL lamp. It is also known that the loudness of the noise depends upon a number of variables, e.g. the peak voltage, the thickness of the lamp, the way in which the lamp is mounted, and the size of the cavity in which the lamp is mounted. Because the energy stored in a capacitor is proportional to the square of the voltage (J=½ CV²), reducing lamp voltage will reduce noise but at the expense of brightness. An otherwise identical but thinner lamp requires less energy to vibrate and a lower voltage will produce as loud a sound as made by a thicker lamp at a higher voltage. Increasing the discharge time dissipates energy over a longer time and little or no sound is produced.

One can easily provide a sinusoidal voltage for an EL lamp if the size of the power supply does not matter. A driver including an LC circuit resonant at low frequency requires an inductor and a capacitor that are physically quite large; too large, for example, for a cellular telephone. Thus, the problem is how to provide a compact driver, suitable for implementing in a single integrated circuit, and how to obtain a sinusoidal voltage from a boost circuit. In either case, the efficiency of the inverter must not be impaired.

In the prior art, U.S. Pat. No. 5,293,098 (Brownell) discloses powering an EL lamp by way of a transformer coupled to a sine wave generator and a power amplifier. U.S. Pat. No. 5,789,870 (Remson) discloses discharging an EL lamp slowly, then more rapidly to avoid the production of audible noise. The contents of the Remson patent are incorporated herein by reference. U.S. Pat. No. 6,038,153 (Andersson et al.) discloses discharging an EL lamp with a series of pulses to approximate a sine wave. U.S. Pat. No. 5,886,475 (Horiuchi et al.) discloses using a ramp voltage to generate timing signals for discharging an EL lamp. With the exception of the Brownell patent, the prior art uses digital signals to approximate a sine wave. As such, there is always some harmonic distortion. See, for example, the data sheet for an SM8146A driver by Seiko NPC Corporation, which discusses harmonic distortion in a pulsed discharge. An analog driver for an EL lamp, if such were commercially available, would be too large for many applications and be relatively expensive due to the high voltages needed by an EL lamp.

In view of the foregoing, it is therefore an object of the invention to a sinusoidal discharge for an EL lamp.

Another object of the invention is to provide an essentially analog discharge in a digital circuit.

A further object of the invention is to eliminate noise from an EL lamp by providing a sinusoidal discharge of the lamp.

### SUMMARY OF THE INVENTION

The foregoing objects are achieved in this invention in which a driver for powering an EL lamp includes a boost circuit for converting low voltage DC to high voltage DC and an inverter for converting direct current to alternating current. The driver also includes at least one transistor for discharging the EL lamp and a generator for producing a ramp voltage that is coupled to the base of the transistor. The ramp voltage causes the discharge current through the EL lamp to be sinusoidal, without harmonics. The discharge current does not cause the EL lamp to produce noise.

### BRIEF DESCRIPTION OF THE DRAWINGS

FIG. 1 illustrates the operation of an H-bridge inverter;

FIG. 2 is a schematic of a commercially available inverter having an H-bridge output;

FIG. 3 is a schematic of an inverter constructed in accordance with a preferred embodiment of the invention for an H-bridge output; and

FIG. 4 is a partial schematic of an inverter constructed in accordance with a preferred embodiment of the invention for a single ended output.

### DETAILED DESCRIPTION OF THE INVENTION

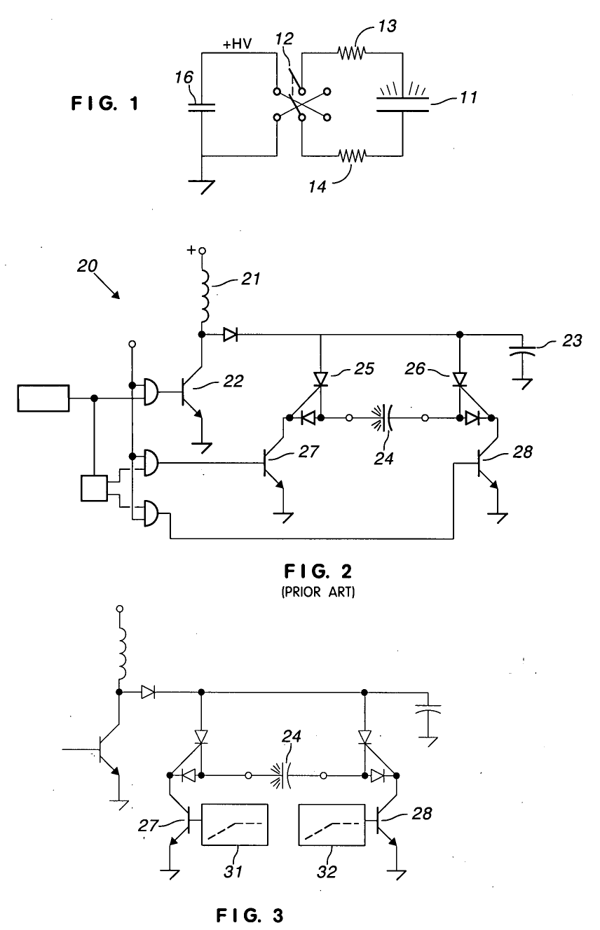

As note above, an electroluminescent lamp requires an alternating current for operation. When a direct current source is all that is available, alternately reversing the connections of an EL lamp and a source of direct current will provide an alternating current. As illustrated in FIG. 1, the terminals of EL lamp 11 are coupled to respective poles of double pole, double throw (DPDT) switch 12 through resistors 13 and 14. The throws of switch 12 are connected to capacitor 16, which stores high voltage DC from a suitable source, not shown. When switch 12 is closed to the left, current flows from the upper electrode of lamp 11 to the lower electrode and flows in the opposite direction when the switch is closed to the right.

FIG. 2 is a schematic of a commercially available driver that includes the electronic counterpart to a DPDT switch. Driver 20 includes inductor 21 and switching transistor 22 operating in a well known boost configuration to charge capacitor 23 to a high, positive voltage with high frequency pulses. EL lamp 24 is connected to the AC diagonal of a bridge including SCR 25, SCR 26, switching transistor 27, and switching transistor 28. Capacitor 23 is connected across the DC diagonal of the bridge. SCR 25 and transistor 28 conduct simultaneously to pass current in a first direction through EL lamp 24. SCR 26 and transistor 27 conduct simultaneously to pass current in a second direction through EL lamp 24, alternating with SCR 25 and transistor 28 at low frequency. EL lamp 24 is discharged by charging to the opposite polarity. There is no separate discharge period. EL lamp 24 is essentially short circuited to the voltage on capacitor 23 when polarity is initially reversed.

FIG. 3 is a schematic of an inverter constructed in accordance with a preferred embodiment of the invention for an H-bridge output. The circuit operates in almost the same manner as the circuit of FIG. 2, except that the voltage applied to the low side switches, transistors 27 and 28, are not pulses but a ramp voltage provided by ramp generators 31 and 32. The duration of the ramp portion is substantially one quarter cycle of the low frequency drive signal.

There are many known ways to generate a ramp voltage. A simple way is to charge a capacitor from a constant current source. This produces a linear (straight) ramp. A non-linear (curved) ramp is produced by charging a capacitor through a series resistor. Whether the curve is convex upward or concave upward depends upon the particular circuit.

When a linear ramp voltage is applied to the base of transistor 27, the transistor becomes slightly conductive and discharge (i.e. charging to the opposite polarity) takes place slowly. As the ramp voltage increases, the rate of discharge increases. The result is a sinusoidal waveform and, despite being an essentially digital circuit, the discharge is analog, i.e. not discontinuous, and is not a simulation or an approximation of a sinusoidal waveform. There are no harmonics.

The voltage on the base of transistor 27 is a ramp for one quarter cycle, then steady for one quarter cycle, while EL lamp 24 charges to the opposite polarity. At the end of the first quarter cycle, EL lamp 24 is substantially discharged. Charging for the second quarter cycle then occurs as in the prior art. The third quarter cycle of the alternating current begins with a ramp voltage from ramp generator 32 applied to transistor 28, which is slightly conductive initially. During the fourth quarter cycle, EL lamp 24 charges to the opposite polarity, as in the prior art. Thus, the low side switches conduct for half cycles each but are fully conductive for only a quarter cycle.

Transistors that are partially conducting dissipate more power than transistors that are fully conducting. One can provide a non-linear ramp to reduce dissipation. Specifically, if the ramp voltage is convex upward, e.g. from the voltage across a capacitor being charged through a resistor, discharge is slightly more rapid initially and the low side switches dissipate less power. Obviously, if the ramp voltage were concave upward, the situation is reversed. If dissipation is not a factor, e.g. for small area lamps, one can tune the discharge for optimum results such as for timing or for whatever other criterion might apply. A linear ramp is preferred.

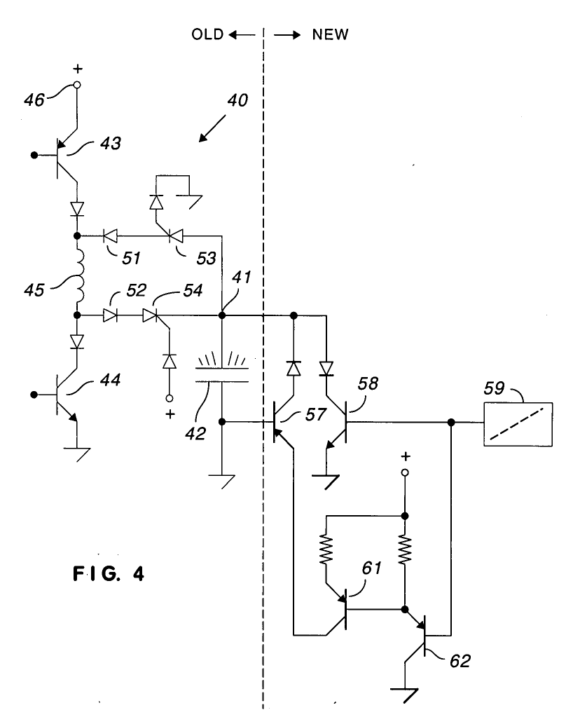

FIG. 4 is a partial schematic of an inverter constructed in accordance with a preferred embodiment of the invention for a boost circuit having a single ended output. In this embodiment, the discharging circuit (“new”) is coupled to output 41 of the charging circuit (“old”). A circuit similar to the charging circuit is described in U.S. Pat. No. 6,320,323 (Buell et al.), the contents of which are incorporated herein by reference, and in U.S. Pat. No. 5,313,141 (Kimball). The charging circuit combines the functions of boost and inverter.

Charging circuit 40 includes transistors 43 and 44 having inductor 45 connected in series between the transistors and the series circuit is connected between DC voltage source 46 and ground. The junction between transistor 43 and inductor 45 is coupled through diode 51 and SCR 53 to output 41. The junction between inductor 45 and transistor 44 is coupled through diode 52 and SCR 54 to output 41. The gate of SCR 53 is coupled to ground and the gate of SCR 54 is coupled to the supply voltage.

Suitable drive signals are applied to the bases of transistors 43 and 44, whereby transistor 43 is turned on and remains on while transistor 44 is turned on and off at a high frequency. While transistor 44 turns on and off at high frequency, diode 52 is forward biased and a series of positive pulse are applied to lamp 42 through SCR 54. The voltage on lamp 42 increases incrementally in response to the pulses and a small current flows through lamp 42.

After a short period, the operation of transistors 43 and 44 is reversed, i.e., transistor 44 conducts while transistor 43 is turned on and off at a high frequency. During this portion of the operation, inductor 45 produces negative pulses that are coupled through diode 51 and SCR 53 to EL lamp 42. The negative pulses charge EL lamp 42 in the opposite direction and current flows in the opposite direction through EL lamp 42.

After another short period, the operation of transistors 43 and 44 is reversed again. The charging periods are separated by discharge periods, during which either transistor 57 or transistor 58 discharges EL lamp 42.

The emitter of transistor 57 is coupled to ramp generator 59 through a bias circuit that includes transistors 61 and 62. The bias circuit inverts or reverses the polarity of the ramp voltage to bias transistor 57 properly for removing negative charge from EL lamp 41. The base of transistor 58 is coupled to ramp generator 59, which biases transistor 58 properly for removing positive charge from lamp 42.

Ramp generator 59 operates intermittently, between charging periods, producing one ramp per discharge. The period for discharge is approximately one quarter cycle of the low frequency alternating current produced across lamp 42. The ramp can be linear or non-linear but linear is preferred.

The invention thus provides a sinusoidal discharge for an EL lamp that is essentially an analog discharge in a digital circuit. The sinusoidal discharge current substantially eliminates noise from being generated by an EL lamp. There are no harmonics.

Having thus described the invention, it will be apparent to those of skill in the art that various modifications can be made within the scope of the invention. For example, although an EL lamp is preferably discharged to ground, an EL lamp can be discharged to a supply voltage. Instead of using the low side switches in an H-bridge, one could add separate discharge circuits, thereby separating the charging circuit from the discharging circuit in an H-bridge. This could be useful for EL lamps having a total area near the limit of the capacity of a driver.

What is claimed as the invention is:

1. A driver for powering an EL lamp, said driver including a boost circuit for converting low voltage DC to high voltage DC and an inverter for converting direct current to alternating current, characterized in that the driver further includes at least one transistor for discharging the EL lamp and a ramp generator coupled to the transistor for controlling the conductivity of the transistor.

2. The driver as set forth in claim 1 wherein the ramp generator produces a linear ramp.

3. The driver as set forth in claim 2 wherein the ramp generator produces a linearly increasing voltage.

4. The driver as set forth in claim 1 wherein the ramp generator produces a nonlinear ramp.

5. The driver as set forth in claim 1 wherein the inverter includes an H-bridge output.

6. The driver as set forth in claim 5 wherein said at least one transistor is part of the H-bridge output.

7. The driver as set forth in claim 1 wherein said driver includes a combined boost circuit and inverter and has a single ended output coupled to said at least one transistor.
